(19) United States
(12) Patent Application Publication
(10) Pub. No.: US 2004/0217695 A1
(43) Pub. Date: Nov. 4, 2004

(54) Organic EL panel and manufacturing method thereof

(76) Inventors: Kiyoshi Yoneda, Mizuho-shi (JP); Ryuji Nishikawa, Gifu-shi (JP)

Correspondence Address: CANTOR COLBURN, LLP, 55 GRIFFIN ROAD SOUTH, BLOOMFIELD, CT, 06002

(21) Appl. No.: 10/627,118

(22) Filed: Jul. 24, 2003

(30) Foreign Application Priority Data
Jul. 25, 2002 (JP) 2002-216663
Jul. 16, 2003 (JP) 2003-275702

(51) Int. Cl. H01J 1/62

(52) U.S. Cl. 313/504

(57) ABSTRACT

An (inner) second planarization film which is an insulating film in the form of a frame and an (outer) second planarization film which has a high profile and pillar shape are formed so as to cover the periphery of a pixel electrode. Subsequently, when an organic emissive layer is subjected to mask evaporation, only a region wherein the (outer) second planarization film is provided comes into contact with the mask. Accordingly, the occurrence of scraping of the mask or dislodging of dust can be reduced, and any resulting scrapings or dust are trapped between the (outer) second planarization film and the (inner) second planarization film.

### BACKGROUND OF THE INVENTION

1. Field of the Invention

The present invention relates to an organic EL panel in which organic EL elements including at least an organic emissive layer are arranged in a matrix form between pixel electrodes, each having a size corresponding to a display region of one pixel, and opposing electrodes opposed to the pixel electrodes, and relates to a method for manufacturing the organic EL panel.

2. Description of the Related Art

Organic electroluminescence display panels (organic EL panels) are one known type of flat display panel. Because, unlike a liquid crystal display (LCD) panel, an organic EL display panel is self-emitting, there is growing expectation that organic electroluminescence displays will become widely used as well-lit, high-viewability flat display panels.

An organic EL panel is typically configured by arranging a plurality of organic EL elements as pixels in a matrix. Each of the organic EL elements has a structure in which a hole transporting layer, an organic emissive layer, and a cathode made of, for example, aluminum are laminated on an anode made of ITO or the like. An electron transporting layer is often provided between the organic. emissive layer and the cathode.

Here, the anode is patterned so as to be present only in a pixel-by-pixel emissive region (to be more precise, the anode is slightly larger than the emissive region). With patterning of the anode (pixel electrode), sharp edges are produced along the periphery of the anode onto which an electric field is concentrated, thereby creating a possibility of short circuiting between the anode and the cathode, which would in turn cause defective display. To prevent this, an insulating film having insulation characteristics is typically formed so as to cover the periphery of the anode. The insulating film is configured such that only the emissive region of the pixel electrode is exposed, and that all other regions are covered. Because formation of the insulating film prevents concentration of electric fields onto the peripheral edges of the pixel electrode and also prevents electrical shorting between the anode and the cathode, suitable emission of the organic EL element is ensured.

Here, in order to execute display of each color or to suppress undesired emission, it is necessary to individually pattern the organic emissive layer on a pixel basis. More specifically, mask evaporation is used to form the organic emissive layer, and, in order to precisely position each pixel pattern, the mask must be placed with great precision.

Such precise positioning of the mask is typically achieved by repeating small movements of the mask for fine adjustment, after the mask is brought into contact with the surface of the hole transporting layer.

However, because the mask is relatively thin and easily deformed, movement of the mask is difficult. Further, when the mask is moved, the hole transporting layer is often damaged or scratched, scrapings may be left behind, and dust adhered to the mask may be peeled off, which may cause a problem that the dropped chips or the peeled dust enter into the organic emissive layer to thereby decouple a film such as the organic emissive layer.

### SUMMARY OF THE INVENTION

The present invention relates to an organic EL panel and enables effective evaporation of an organic emissive layer.

According to the present invention, an insulating film which covers peripheral edges of a pixel electrode is formed in the shape of a frame and a protrusion having a thickness greater than the insulating film is provided on the outside of the insulating film. Accordingly, a mask used for evaporation of an organic film such as an organic emissive layer is supported by the protrusion on the outside of a pixel electrode. As a result, even if scrapings or dust are produced during positioning of the mask, a possibility that the scrapings or the dust would enter into the organic emissive layer and others is very low. Further, because the mask is supported by the protrusion, an area of contact with the mask becomes small, which enables easy positioning achieved by moving the mask.

Further, by forming the protrusion using a material equal to that of the insulating film, the protrusion and the insulating film can be sequentially formed to thereby facilitate easy formation thereof.

Still further, by configuring the protrusion with a plurality of pillar components arranged so as to discretely surround the periphery of the insulating film, the area of contact with mask can be reduced.

Further, by forming a recessed groove in the form of a frame, from which the insulating film is removed, between the insulating film and the protrusion, the recess can trap the scrapings or the dust produced due to contact between the mask and the protrusion.

In a method according to the present invention, the organic emissive layer may be formed while the protrusion is supporting the mask.

Further, it is preferable to form regions on which the insulating film is remained and from which the insulating film is removed by gray-tone exposure using irradiation light of varying strengths.

### BRIEF DESCRIPTION OF THE DRAWINGS

FIG. 1 is a cross section showing the structure of a pixel region configured according to the present invention:

FIGS. 2A and 2B are drawings for explaining shapes of a pixel electrode, an (inner) second planarization film which is an insulating film, and an (outer) second planarization film being a mask supporting member;

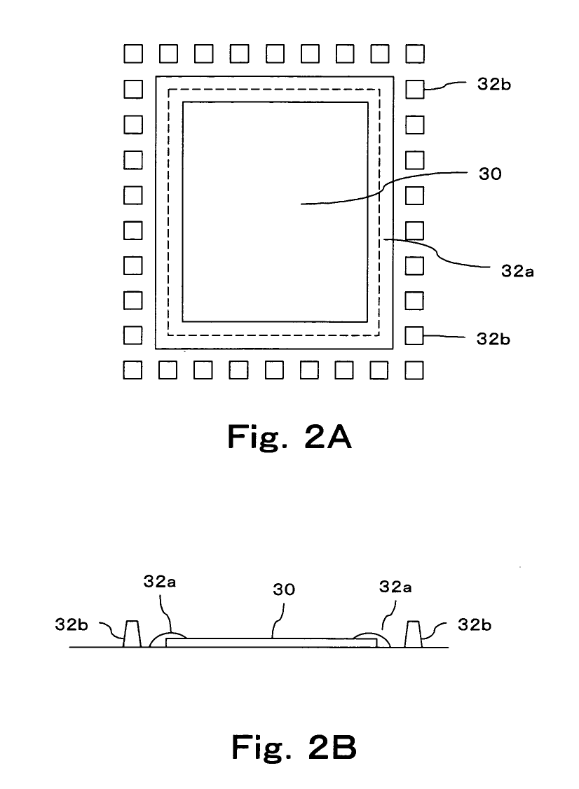

FIG. 3 shows a situation in which a mask is placed;

FIGS. 4A and 4B are plan view and sectional view of a mask for exposure having gray-tone openings, respectively;

FIG. 5A shows a situation in which a donor sheet is placed, and FIG. 5B shows another situation in which an organic material layer in a predetermined portion of the donor sheet is deposited on an electrode;

FIGS. 6A and 6B are drawings showing two-step exposure, and

FIGS. 7A and 7B show other forms of the (outer) second planarization film.

### DESCRIPTION OF THE PREFERRED EMBODIMENT

Referring to the drawings, a preferred embodiment of the present invention will be described below.

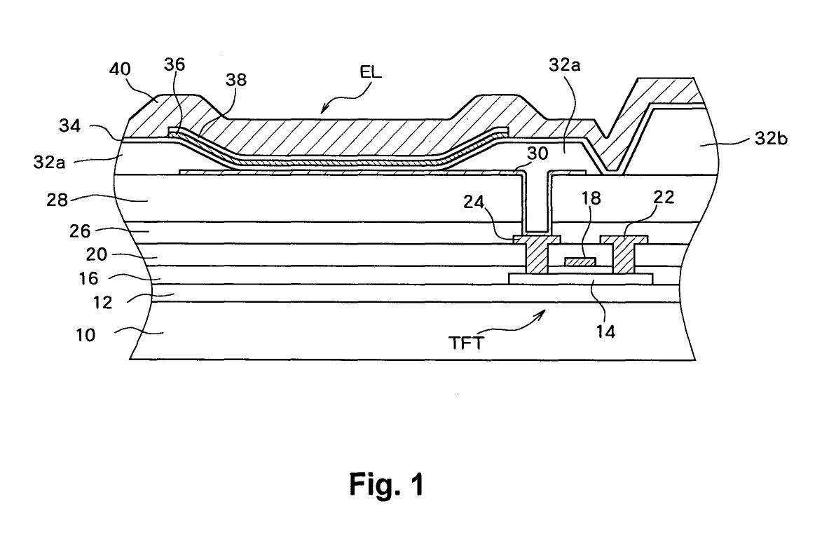

FIG. 1 is a cross sectional view showing significant components of pixel regions configured according to the preferred embodiment. An insulating layer 12 comprising two layers of SiNx and SiO₂ laminated in that order is formed over the entire surface of a glass substrate 10 to avoid intrusion of impurities from the glass substrate 10 side. In predetermined regions above the insulating film 12, a great number of thin film transistors are formed. FIG. 1 shows a second TFT which is a thin film transistor for controlling an electric current from a power supply line to an organic EL element. It should be noted that each pixel is provided with a first TFT for controlling the accumulation of a voltage from a data line into a capacitor. The second TFT is turned on according to the voltage accumulated in the capacitor to control the current from the power supply line to the organic EL element.

A semiconductor layer 14 made of polysilicon and forming an active layer is formed on the insulating film 12, and a gate insulating film 16 of a two-layer film in which SiO₂ and SiNₓ are laminated in that order is also formed so as to cover the semiconductor layer 14. In an upper area above the middle of the semiconductor layer 14, a gate electrode 18 made of Mo and others is formed through the intermediary of the gate insulating film 16. An interlayer insulating film 20 which is a two-layer insulating film made of SiNₓ and SiO₂ laminated in that order is formed so as to cover both the gate electrode 18 and the gate insulating film 16. Further, contact holes are made through the interlayer insulating film 20 and the gate insulating film 16 on both ends of the semiconductor layer 14 to form a drain electrode 22 made of, for example, aluminum and a source electrode 24 in the contact holes.

The interlayer insulating film 20, the drain electrode 22, and the source electrode 24 are covered with a moisture blocking layer 26 made of SiNₓ, or a TEOS film formed over the entire surface.

Further, on the moisture blocking layer 26, a fist planarization film 28 made of an organic material such as acrylic resin is formed and thereon a pixel electrode 30 made of ITO or the like is formed as an anode of an organic EL element for each pixel.

The pixel electrode 30, a part of which reaches to the upper surface of the source electrode 24, is also formed on the inner wall of a contact hole provided to expose the upper surface of the source electrode 24, to thereby establish direct contact between the source electrode 24 and the pixel electrode 30.

The periphery of the pixel electrode 30 other than an emissive region is covered with a second planarization film 32 made of an organic material similar to the material from which the first planarization film 28 is formed. Accordingly, the second planarization film 32 has the form of a frame surrounding the periphery of the pixel electrode. Although the pixel electrode is formed in substantial rectangular shape and the second planarization film 32 is in the form of a rectangular frame in this embodiment, the second planarization film 32 is not limited to the form of a frame and may be formed in the shape according to the shape of a pixel electrode.

Then, a hole transporting layer 34 is formed over the entire area of both the second planarization film 32 and the pixel electrode 30. Because the second planarization film 32 has an opening in the emissive region, the hole transporting layer 34 comes into direct contact with the pixel electrode 30 being an anode in the emissive region. An emissive layer 36 and an electron transporting layer 38 both of which are slightly larger than the emissive region and divided into pixel-by-pixel segments are formed, in that order, on the hole transporting layer 34, over the entire area of which a cathode 40 made of, for example, is formed. More specifically, both the organic emissive layer 36 and the electron transporting layer 38, which are formed so as to be larger than the emissive layer for handling position drifts during formation, extend to an area above the second planarization film 32 but immediately terminate at the area above the second planarization film 32, thereby limiting their presence to only the area within the pixel region.

In the above-described structure, when the second TFT is turned on, a current is supplied to the pixel electrode 30 of the organic EL element through the source electrode 24 and then the passage of current between the pixel electrode 30 and the cathode 40 is established so that the organic EL element emits in accordance with the current.

According to this embodiment, the second planarization film 32 covering the periphery of the pixel electrode 30 is patterned. More specifically, the second planarization film 32 comprises an (inner) second planarization film 32a, which ends in the vicinity of the pixel electrode 30 rather than widely extending on either side from the vicinity of the pixel electrode 30 and has a relatively low profile, and an (outer) second planarization film 32b formed so as to surround the (inner) second planarization film 32a, while leaving a slight clearance between the films.

The (inner) second planarization film 32a is provided to cover the peripheral edges of the pixel electrode 30, thereby being formed in continuous frame shape which covers the periphery of the pixel electrode 30. On the other hand, because the (outer) second planarization film 32b is provided to support a mask for evaporation used during formation of the organic emissive layer 36 of organic EL and electron transporting layer 38, this layer is not necessarily formed in a continuous shape. Accordingly, the (outer) second planarization film 32b is formed in the form pillars instead of a continuous frame and is then configured by arranging a plurality of pillars at established intervals to form a frame-like configuration. The (outer) second planarization film 32b is higher than the (inner) second planarization film 32a. Further, the (outer) second planarization film 32b and the (inner) second planarization film 32a are made of the same material, and usually deposited in the same process and then formed so as to differ in height by patterning.

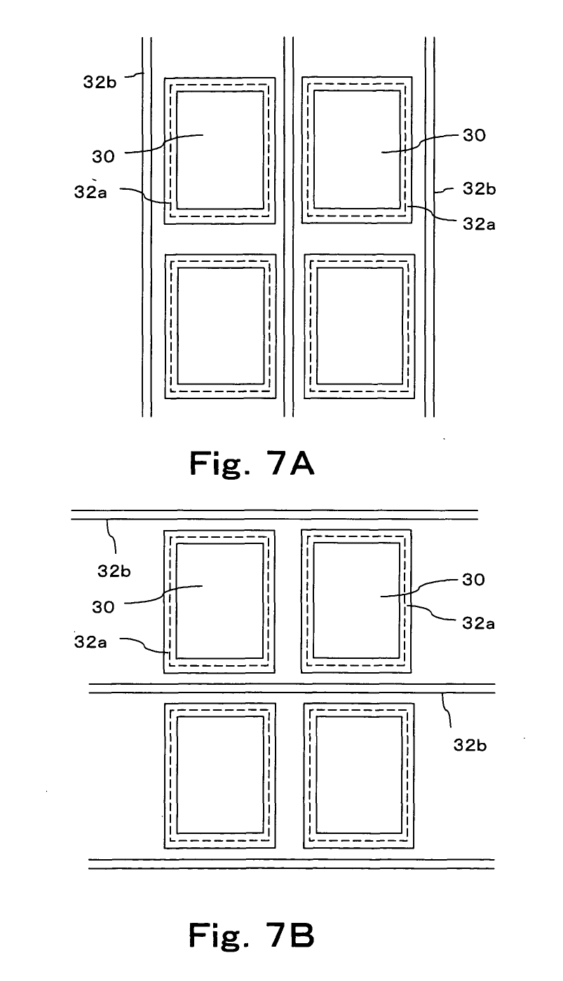

Further, the (outer) second planarization film 32b may be a protrusion in the form of a straight line as shown in FIGS. 7A and 7B. More specifically, the (outer) second planarization film 32b is formed as protrusions extending in a column direction in FIG. 7A, and formed as protrusions extending in a row direction in FIG. 7B. Although the (outer) second planarization film 32b is formed in the form of a continuous straight line in this example, this film may be configured by arranging protrusions each being in the form of a pillar as in the case with the former example. It should be noted that, for the sake of clarity, FIGS. 7A and 7B show only 4 pixels among the pixels arranged in matrix form.

A region in the form of a frame wherein the first planarization film 28 is exposed is provided outside of the second planarization film 32a, and in region still further external therefrom, the (outer) second planarization film 32b having the higher profile is formed.

An organic EL panel having the above-described pixel structure is produced as follows. First, the second TFTs, the first TFTs, and TFTs of peripheral driver circuits are formed on the glass substrate 30 in the same process, and the entire surface is covered with the first planarization film 28 and then planarized.

Next, the contact hole reaching to the source electrode 24 is formed, and then ITO is deposited by spattering. Subsequently, the pixel electrode 30 is patterned in the shape of the emissive region (rectangular shape) by etching.

After patterning of the pixel electrode 30, a second planarization film 32 made of acrylic resin having a photosensitive agent is spin-coated over the entire surface, and then light is irradiated onto either an unnecessary or a necessary portion of the second planarization film 32 for patterning by photolithography.

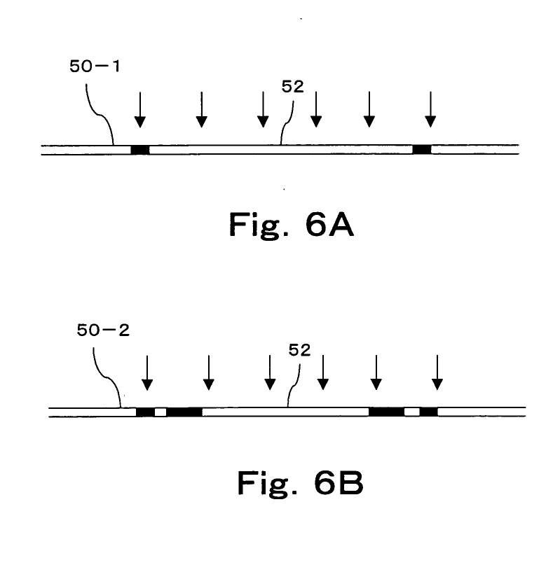

Patterning of the second planarization film 32 and the (outer) second planarization film 32b is carried out by, for example, two-step exposure. In order to execute the two-step exposure, the second planarization film 32 is formed over the entire surface, first. Next, a first exposure to light is performed on regions other than the (outer) second planarization film 32b using a first mask 50-1 as shown in FIG. 6A. Following the first exposure, a second exposure to light is performed on regions excluding both the second planarization film 32 and the (outer) second planarization film 32b using a second mask 50-2 as shown in FIG. 6B. Accordingly, the (outer) second planarization film 32b is subjected to neither the first nor the second exposure to light, and the (inner) second planarization film 32a is only subjected to the second exposure to light.

After the exposure, the portions exposed to light are removed by etching. Consequently, all of the organic material is removed from the regions twice exposed to light, and the (inner) second planarization film 32a is subjected to a removal such that the height of the (inner) second planarization film 32a is reduced.

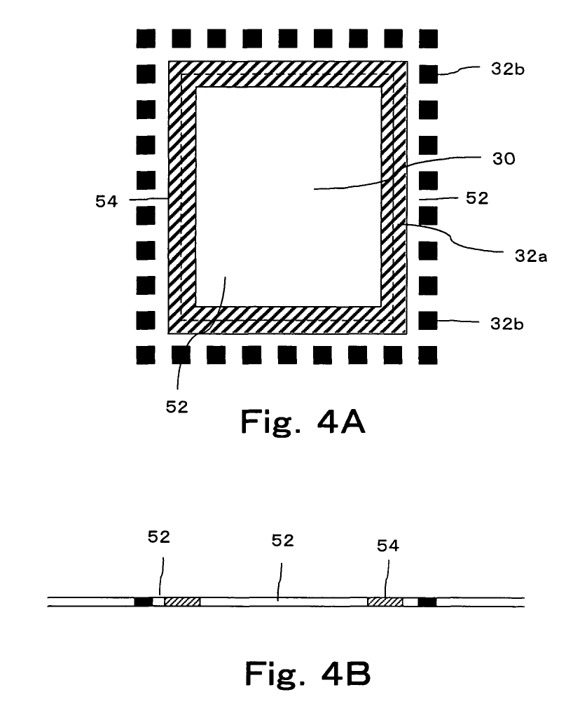

Instead of the two-step exposure described above, a one-step exposure process may be used. In such a one-step exposure, gray-tone exposure is carried out. That is, a gray-tone mask having openings formed in the shape of slits or a grid is used as a mask for exposure. More specifically, as shown in FIGS. 4A and 4B, a part of the mask corresponding to the region where a greater exposure value is desired for removing the second planarization film 32 is formed as a normal opening 52, and another part of the mask corresponding to the (inner) second planarization film 32a is formed as an opening 54 in the form of a grid. With such a mask configuration, an aperture ratio of the opening 54 can be predetermined, to thereby achieve exposure according to the desired amount of removal of the second planarization film, which subsequently enables depth removal at two levels by downstream etching.

Through the above-described exposure and etching, the (inner) second planarization film 32a in the form of a frame which covers the peripheral edges of the rectangular pixel electrode 30 and the (outer) second planarization film 32b comprising protrusions each in the shape of a pillar arranged so as to surround the outside of the (inner) second planarization film 32a with clearance in-between are formed.

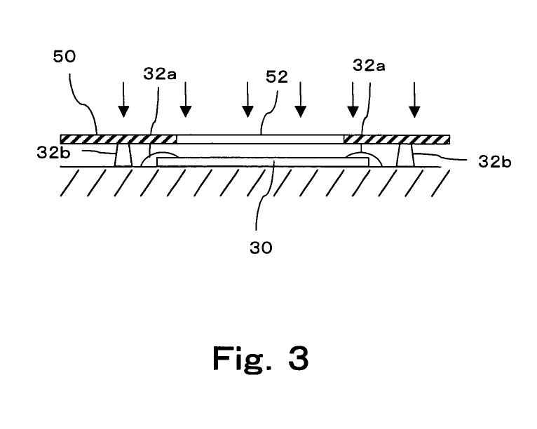

Next, the hole transporting layer 34 is formed over the entire surface through vacuum evaporation, and a mask used for mask evaporation of the organic emissive layer 36 is placed on the hole transporting layer 34. This situation is shown in FIG. 3. As shown in FIG. 3, a mask 50 is supported by the top of the (outer) second planarization film 32b. The mask 50 made of, for example, nickel in which an area slightly larger than the pixel electrode 30 is formed as an opening 52, is fixed at a position where the opening 52 aligns with the pixel electrode 30. After the mask is positioned, the organic emissive layer 36 is vacuum evaporated.

Subsequently, the electron transporting layer 38 is vacuum evaporated with the mask in place, and then the cathode 40 is vacuum evaporated after the mask has been removed. As a result of the above-described procedure, any need to change masks is eliminated, and the possibility of the intrusion of dust can be reduced. It should be noted that, by increasing an anisotropic factor in evaporation of the electron transporting layer 38, the electron transporting layer 38 can be formed to be smaller than the organic emissive layer 36 even using the same mask, such the electron transporting layer 38 can be firmly supported on the organic emissive layer 36.

The pixel electrode 30 may be, for example, 60 μm by 60 μm, and the second planarization film 32 may have a width of approximately 10-20 μm and may overlap pixel electrode 30 by an amount on the order of several μm.

After the completion of patterning of the second planarization film 32 as described above, each of the layers comprising the organic EL elements is evaporated. Because precise positioning of the mask is important for evaporation of the layers, the positioning of the mask is carried out in a state where the mask is in contact with the hole transporting layer 34.

In the present example of the preferred embodiment, the mask partially contacts with the hole transporting layer 34 at regions where the (outer) second planarization film 32b is provided as a mask support (a protrusion). Accordingly, because the area of contact with the mask is relatively small, the mask can easily be positioned.

Further, when the mask is moved or repositioned, the hole transporting layer 34 may be chipped or scraped or that dust stuck to the mask may be dislodged. In this embodiment, however, the region (the recessed groove) where the second planarization film 32 is not provided is formed so as to surround the (inner) second planarization film 32a in the inside of the (outer) second planarization film 32b. Further, the (outer) second planarization film 32b is formed in pillar shape and has a recess in the surrounding area. Accordingly, dislodged particles or dust produced when the mask is positioned are trapped in the recess around the (outer) second planarization film 32b, which keep the scraped chips and the dust from spreading to other regions. In particular, the particles and dust which fall inside of the (outer) second planarization film 32b are trapped in the recessed groove, to thereby effectively prevent the scraped chips and the dust from reaching the pixel electrode 30. Hence, particles or dust lying on the pixel electrode 30, which detrimentally effect the relatively thin organic films of the organic EL, can be reliably prevented. The thicknesses of the respective layers may be as follows: the hole transporting layer 34 is approximately 150-200 nm, the organic emissive layer 36 is on the order of 35 nm, the electron transporting layer 38 is on the order of 35 nm, and the cathode 40 is approximately 300-400 nm. Although a significant detrimental effect would arise when the scraped chips or the dust have a diameter on the order of 100 nm, such detrimental effect can effectively be prevented according to this embodiment.

As described above, instead of forming the second planarization film 32 over the entire surface, formation of the second planarization film 32 is limited to the surrounding areas of the pixel electrode 30, and a two-level height is given to the second planarization film 32, provided with the recessed groove in-between. Therefore, the mask used for forming the organic emissive layer 36 is supported only on regions where the (outer) second planarization film 32b is formed. This manner of supporting makes the area of contact with the mask small, which in turn enables easy movement and easy alignment of the mask. Further, even if the scraped chips and/or the dust fall down during positioning of the mask, they could be trapped in the recessed groove, which reduces a possibility of the occurrence of a problem on the organic layer in the pixel region.

It is also preferable to form a support member for bearing the mask, which is similar to the (outer) second planarization film 32b, on regions not associated with display as appropriate when the second planarization film 32 is formed. Formation of the additional support member makes it possible to appropriately support the mask in addition to enabling positioning of the mask. The support member may be formed so as to cover the overall driver circuit on the periphery of the display region, or may be formed so as to cover a part of the driver circuit.

When the pixel electrode has a shape other than a rectangle, the second planarization film support member may be placed on the periphery of the pixel electrode. That is, the expression “form of a frame” as used above includes non-rectangular shapes of a frame, as in the above case.

[Insertion]

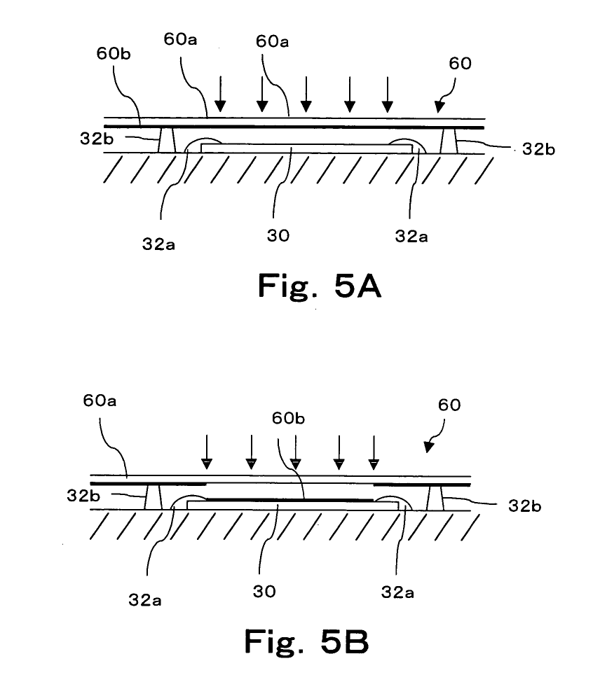

Although the organic organic EL film in the above example is formed by vacuum evaporation, other methods, such as a method using a donor sheet may be utilized. When an emissive layer is formed, for example, after forming the hole transporting layer on the pixel electrode 30, a donor sheet 60 in which an organic material layer 60b for the emissive layer desired to be formed is formed on a base material 60a of plastic by evaporation is placed in such a manner that the organic material layer 60b faces the pixel electrode (hole transporting layer) as shown in FIG. 5A. The donor sheet 60 is supported on the top of the (outer) second planarization film 32b as in the case of the above-described mask. In this situation, laser light (shown by arrows in the figure) is irradiated onto a portion of the donor sheet 60 corresponding to the pixel. With laser irradiation, the organic material layer 60b in the areas where laser light is irradiated are dispersed by laser heat and then deposited on the pixel electrode (via the hole transporting layer). For example, after placement of a red donor sheet, laser light is irradiated onto a portion of the red donor sheet situated above each of the pixels for red to form a red emissive layer. By repeating similar processes for green, blue, and red, the organic films can be formed on the pixel electrodes. In a similar fashion, the electron transporting layer and other layers may be formed.

Here, because the (outer) second planarization film 32b can support the donor sheet 60, the occurrence of errors such as adhesion of the organic material onto an inappropriate portion is effectively prevented. Further, by using the donor sheet 60, the need for using an evaporation mask is eliminated, which simplifies formation of an organic film on a large substrate. It should be noted that either plastic or glass, or any other acceptable material, may be used as a material of the base material 60a for the donor sheet.

As described above, according to the present embodiment, the insulating film covering the peripheral edges of the pixel electrode is formed in the shape of a frame and the protrusion for supporting the mask which is of a greater thickness is provided on the outside of the insulating film. Accordingly, the mask used for evaporating the organic layer such as the organic emissive layer is supported by the protrusion provided outside of the pixel electrode, which reduces the possibility of intrusion of scrapings or dust into the organic emissive layer, even if such scrapings or dust are produced during positioning of the mask. Further, because the mask is supported by the protrusion, the area of contact with the mask can be minimized to thereby facilitate positioning of the mask.

When the protrusion and the insulating film are formed using the same material, the insulating film and the protrusion can be sequentially formed, which results in that both of them can easily be formed.

Further, by discretely forming the protrusion in the surrounding area of the insulating film, the area of contact with the mask can be minimized.

Because the recessed groove formed in the shape of a frame is formed between the insulating film and the protrusion, scrapings and/or the dust produced due to contact between the mask and the protrusion can be trapped in the recessed groove, thereby reducing the occurrence of adverse effects on the organic emissive layer and other layers.

What is claimed is:

1. An organic EL panel in which organic EL elements including at least an organic emissive layer are arranged in matrix form between pixel electrodes each having a size corresponding to an emissive region of one pixel and opposing electrodes being opposed to the pixel electrodes, the organic EL panel comprising:
an insulating film in the form of a frame which covers peripheral edges of each of the pixel electrodes, and
a protrusion having a thickness greater than that of said insulating film and provided on the outside of the insulating film.

2. An organic EL panel according to claim 1, wherein said protrusion is made of the same material as said insulating film.

3. An organic EL panel according to claim 1, wherein said protrusion is configured by arranging a plurality of pillar components so as to discretely surround the periphery of the insulating film.

4. An organic EL panel according to claim 1, wherein a recess in the form of a frame from which said insulating film is removed is formed between said insulating film and the protrusion.

5. An organic EL panel according to claim 1, wherein said protrusion works as a mask support for bearing a mask for evaporation.

6. An organic EL panel according to claim 1, wherein said protrusion works as a support for bearing a donor sheet which releases an organic material by laser irradiation.

7. A method of manufacturing an organic EL panel in which organic EL elements including at least an organic emissive layer are arranged in matrix form between pixel electrodes each having a size corresponding to an emissive region of one pixel and opposing electrodes being opposed to the pixel electrodes, the manufacturing method comprising the steps of:
forming the pixel electrodes;
forming an insulating film in the form of a frame, which covers peripheral edges of each of the pixel electrodes, and a protrusion, provided on the outside of the insulating film and having a thickness greater than that of the insulating film, on the pixel electrodes, and
forming the organic emissive layer while the protrusion is supporting a mask.

8. A method of manufacturing an organic EL panel according to claim 7, wherein said insulating film and the protrusion are formed through a two-step exposure process comprising a first exposure to light for forming the thickness of said insulating film and a second exposure to light for removing the insulating film.

9. A method of manufacturing an organic EL panel according to claim 7, wherein said insulating film and the protrusion are formed through a gray-tone exposure processing of a region where said insulating film is formed such that light exposure varies among the a portion of the region from which said insulating film is removed, a portion of the region on which said insulating film is provided, and a portion of the region on which said protrusion is provided.

10. A method of manufacturing an organic EL panel in which organic EL elements including at least an organic emissive layer are arranged in matrix form between pixel electrodes each having a size corresponding to an emissive region of one pixel and opposing electrodes being opposed to the pixel electrodes, the manufacturing method comprising the steps of:
forming the pixel electrodes;
forming an insulating film in the form of a frame, which covers peripheral edges of each of the pixel electrodes, and a protrusion, provided on the outside of the insulating film and having a thickness greater than that of said insulating film, on the pixel electrodes, and
forming the organic emissive layer such that, while said protrusion is supporting a donor sheet on which a layer made of an organic emissive material is formed, the organic emissive material is released from said donor sheet by laser irradiation so as to be deposited on said pixel electrodes.

11. A method of manufacturing an organic EL panel according to claim 10, wherein said insulating film and the protrusion are formed through a two-step exposure process comprising a first exposure to light for forming the thickness of said insulating film and a second exposure to light for removing the insulating film.

12. A method of manufacturing an organic EL panel according to claim 10, wherein said insulating film and the protrusion are formed through a gray-tone exposure processing of a region where said insulating film is formed such that light exposure varies among the a portion of the region from which said insulating film is removed, a portion of the region on which said insulating film is provided, and a portion of the region on which said protrusion is provided.
